(19) United States
(12) Patent Application Publication
(10) Pub. No.: US 2017/0348792 A1
(43) Pub. Date: Dec. 7, 2017

(54) METHOD FOR ADDITIVE MANUFACTURING

(71) Applicant: Arcam AB, Moelndal (SE)

(72) Inventor: Mattias Fager, Goeteborg (SE)

(21) Appl. No.: 15/495,348

(22) Filed: Apr. 24, 2017

Related U.S. Application Data
(60) Provisional application No. 62/344,075, filed on Jun. 1, 2016.

(51) Int. Cl. B23K 15/00; B33Y 50/02; B23K 26/342; B33Y 10/00; B33Y 30/00; B23K 15/06; B23K 103/04; B23K 103/18; B23K 103/10; B23K 103/14

(52) U.S. Cl. CPC B23K 15/0086; B33Y 30/00; B33Y 50/02; B23K 26/342; B23K 15/06; B33Y 10/00; B23K 2203/26; B23K 2203/10; B23K 2203/14; B23K 2203/05

(57) ABSTRACT

A method is provided for forming a three-dimensional article through successive fusion of parts of a metal powder bed, which parts corresponds to successive cross sections of the three-dimensional article, the method comprising the steps of: directing the at least one electron beam from the at least one electron beam source over a work table causing a powder layer to fuse in selected locations to form a first cross section of the three-dimensional article, preheating, with the at least one electron beam, an area of non-fused powder to a temperature within a predetermined temperature range a predetermined distance in Z-direction before the area is to be fused, where the area times the distance in z-direction is defining a preheating volume of non-fused powder when the three dimensional article is finished.

### CROSS-REFERENCE TO RELATED APPLICATIONS

This application claims priority to and the benefit of U.S. Provisional Patent Application Ser. No. 62/344,075, filed Jun. 1, 2016, the contents of which as are hereby incorporated by reference in their entirety.

### BACKGROUND

### Related Field

Freeform fabrication or additive manufacturing is a method for forming three-dimensional articles through successive fusion of chosen parts of powder layers applied to a worktable.

Such an apparatus may comprise a work table on which the three-dimensional article is to be formed, a powder dispenser, arranged to lay down a thin layer of powder on the work table for the formation of a powder bed, an energy beam for delivering energy to the powder whereby fusion of the powder takes place, elements for control of the energy given off by the energy beam over the powder bed for the formation of a cross section of the three-dimensional article through fusion of parts of the powder bed, and a controlling computer, in which information is stored concerning consecutive cross sections of the three-dimensional article. A three-dimensional article is formed through consecutive fusions of consecutively formed cross sections of powder layers, successively laid down by the powder dispenser.

When an energy beam in the form of an electron beam hits the powder, a charge distribution develops around the electron target area. Desirably, this charge will be led through a produced part of the article to be made and/or the powder bed towards ground. If the charge distribution density exceeds a critical limit, an electrical field having field strength above a predetermined level will develop around the position where the beam is radiating. The electrical field having electrical field strength above the predetermined level will be referred to as Eₘₐₓ. An electrical field will cause the powder particles to repel each other such that particles leave the uppermost surface layer of the powder bed and create a distribution of particles floating above the surface. The floating particles resemble a cloud positioned above the surface. When the electrical field has field strength above Eₘₐₓ, the electrical field, i.e. the particle cloud or smoke of powder, will influence the resolution of the device in a negative way. This is partly due to the fact that the particles in the particle cloud will diverge the electron beam. When the electrical field has field strength below Emax, the electrical field, i.e. the particle cloud, will not influence the resolution of the device in a significant way. A field strength below Eₘₐₓ is thus desirable.

Since the particles are charged they will seek a ground contact and thereby some may leave the cloud and will then contaminate different parts of the device being positioned inside the vacuum chamber. A result of such a critical electrical field is that the structure of the powder surface will be destroyed.

### Description of Related Art

One solution to the problem of avoiding charging of powder is disclosed in WO 2008/147306. In the document the amount of ions present in close vicinity to the position where the electron beam radiates the powder material is controlled. This is according to one example embodiment performed by introducing a supplementary gas into the vacuum chamber, which is capable of producing ions when irradiated by the electron beam.

The above mentioned method may be successful for some three-dimensional shapes but not all of them. For instance if a three-dimensional article is to be build which needs a lot of support structures for a surface belonging to the three-dimensional article which is to be built on unfused powder material, cloud or smoke of powder may nevertheless be created which is a problem.

### BRIEF SUMMARY

An object of the invention is to provide a method for additive manufacturing with electron beam melting in which all shapes of three-dimensional articles may be built without risking cloud or smoke of powder. This object is achieved by the features in the method according the claims recited herein.

In a first aspect of the invention it is provided a method for forming a three-dimensional article through successive fusion of parts of a metal powder bed, which parts corresponds to successive cross sections of the three-dimensional article, the method comprising the steps of: providing a vacuum chamber, providing at least one electron beam source, providing a powder layer on a work table inside the vacuum chamber, directing the at least one electron beam from the at least one electron beam source over the work table causing the powder layer to fuse in selected locations to form a first cross section of the three-dimensional article, lowering the work table a predetermined distance in Z-direction, providing a second powder layer on the work table inside the build chamber, directing the at least one electron beam over the work table causing the second powder layer to fuse in selected locations to form a second cross section of the three-dimensional article, wherein the second layer is bonded to the first layer, and preheating, with the at least one electron beam, an area of non-fused powder to a temperature within a predetermined temperature range a predetermined distance in Z-direction before the area is to be fused, where the area times the distance in z-direction is defining a preheating volume of non-fused powder when the three dimensional article is finished.

In one example of this first aspect of the present invention, the method may involve, in particular, the steps of: distributing a powder layer on a work table inside a build chamber, directing at least one beam from at least one high energy beam source over the work table causing the powder layer to fuse in selected locations to form a first cross section of the three-dimensional article, lowering the work table a predetermined distance in Z-direction, distributing a second powder layer on the work table inside the build chamber, directing the at least one beam over the work table causing the second powder layer to fuse in selected locations to form a second cross section of the three-dimensional article, wherein the second layer is bonded to the first layer, and preheating, with the at least one beam, an area of non-fused powder to a temperature within a predetermined temperature range a predetermined distance in Z-direction before the area is to be fused, wherein the area times the distance in z-direction is defining a preheating volume of non-fused powder when the three dimensional article is finished.

An exemplary advantage of various embodiments of the present invention is that sudden lateral extensions in an electron beam additive manufacturing process will not cause process instability.

In one example embodiment of the present invention the preheating of the area of non-fused powder is performed at least 5 or 10 powder layers before the actual fusing of the area is taking place. An exemplary advantage of at least this embodiment is that a control unit can be set to look ahead a predetermined number of layers in order to determine if there are any lateral extensions to the three-dimensional which is to be built. If any such lateral extensions are detected one can start to preheat a predefined area under the forthcoming lateral extension.

In another example embodiment of the present invention a thickness of a powder layer is between 10-200 μm. An exemplary advantage of at least this embodiment is that it is applicable for any powder layer thickness.

In another example embodiment the temperature range is between 400-1300° C. An exemplary advantage of at least this embodiment is that the present invention works for a great majority of existing metal powder alloys.

In another example embodiment the preheating is performed so that a mean temperature within the preheating volume is at least 300° C. above a mean temperature of the same volume without preheating. An exemplary advantage of at least this embodiment is that the powder material temperature is increased sufficiently for increasing its electrical conductivity and/or for removing surface oxides present on powder particles which will greatly reduce the risk of charging the powder material above its critical value when the powder material is starting to lift from the work table (so called powder smoke).

In another example embodiment of the present invention the preheating volume has a rectangular or trapezoid cross section. An exemplary advantage of at least this embodiment is that a lateral extension of an individual layer inside the preheating volume located directly below a lateral extension to the three-dimensional article which is to be fused, can be different for different layers inside the volume.

In another example embodiment of the present invention the area of the preheating volume, next to the area which is to be fused, is larger and fully overlapping with the area which is to be fused or identical and centered with the area which is to be fused. An exemplary advantage of at least this embodiment is that the last preheated cross section of powder material inside the preheating volume directly below, i.e., adjacent to, the lateral extension of the three-dimensional article, is larger than the actual area of the lateral extension which is to be preheated or identical and centered with the lateral extension of the three dimensional article which is to be fused.

In another aspect of the present invention it is provided a an apparatus for forming a three-dimensional article through successive fusion of parts of a metal powder bed, which parts corresponds to successive cross sections of the three-dimensional article, the apparatus comprising: a vacuum chamber; a working table onto which layers of powdery material are to be placed; at least one electron beam source; and at least one control unit, wherein the apparatus is configured, via the at least one control unit, for: distributing a layer on the work table inside the vacuum chamber, directing the at least one electron beam from the at least one electron beam source over the work table causing the powder layer to fuse in selected locations to form a first cross section of the three-dimensional article, distributing a second powder layer on the work table inside the build chamber, directing the at least one electron beam over the work table causing the second powder layer to fuse in selected locations to form a second cross section of the three-dimensional article, wherein the second layer is bonded to the first layer, and preheating, with the at least one electron beam, an area of non-fused powder to a temperature within a predetermined temperature range a predetermined distance in Z-direction before the area is to be fused, where the area times the distance in z-direction is defining a preheating volume of non-fused powder when the three dimensional article is finished.

In another aspect according to various embodiments of the present invention, there is provided an apparatus for forming a three-dimensional article through successive fusion of parts of a metal powder bed, which parts corresponds to successive cross sections of the three-dimensional article, the apparatus comprising: a build chamber; a working table onto which layers of powdery material are to be placed; at least one high energy beam source; and at least one control unit, wherein the apparatus is configured, via the at least one control unit, for: distributing a layer on the work table inside the vacuum chamber, directing the at least one e beam from the at least one high energy beam source over the work table causing the powder layer to fuse in selected locations to form a first cross section of the three-dimensional article, distributing a second powder layer on the work table inside the build chamber, directing the at least one beam over the work table causing the second powder layer to fuse in selected locations to form a second cross section of the three-dimensional article, wherein the second layer is bonded to the first layer, and preheating, with the at least one beam, an area of non-fused powder to a temperature within a predetermined temperature range a predetermined distance in Z-direction before the area is to be fused, wherein the area times the distance in z-direction defines a preheating volume of non-fused powder when the three dimensional article is finished.

Also provided according to various embodiments is a computer program product comprising at least one non-transitory computer-readable storage medium having computer-readable program code portions embodied therein, the computer-readable program code portions comprising at least one executable portion configured for: directing at least one beam from at least one high energy beam source over a work table causing a powder layer thereon to fuse in selected locations to form a first cross section of the three-dimensional article, lowering the work table a predetermined distance in Z-direction, distributing a second powder layer on the work table inside the build chamber, directing the at least one beam over the work table causing the second powder layer to fuse in selected locations to form a second cross section of the three-dimensional article, wherein the second layer is bonded to the first layer, and preheating, with the at least one beam, an area of non-fused powder to a temperature within a predetermined temperature range a predetermined distance in Z-direction before the area is to be fused, wherein the area times the distance in z-direction is defining a preheating volume of non-fused powder when the three dimensional article is finished.

All examples and exemplary embodiments described herein are non-limiting in nature and thus should not be construed as limiting the scope of the invention described herein. Still further, the advantages described herein, even where identified with respect to a particular exemplary embodiment, should not be necessarily construed in such a limiting fashion.

### BRIEF DESCRIPTION OF SEVERAL VIEWS OF THE DRAWINGS

The invention will be further described in the following, in a non-limiting way with reference to the accompanying drawings. Same characters of reference are employed to indicate corresponding similar parts throughout the several figures of the drawings:

FIG. 1A depicts, in a schematic cross sectional view, a first example embodiment of a partly finished three-dimensional article,

FIG. 1B depicts, in a schematic cross sectional view, a second example embodiment of a partly finished three-dimensional article,

FIG. 2 shows, in a schematic view, an example embodiment of a device for producing a three dimensional product in which device a first example embodiment of the inventive method can be applied,

FIG. 3 depicts, in schematic view, an example of the surface of the powdery material with a charged particle cloud,

FIG. 4 is a block diagram of an exemplary system 1020 according to various embodiments,

FIG. 5A is a schematic block diagram of a server 1200 according to various embodiments, and

FIG. 5B is a schematic block diagram of an exemplary mobile device 1300 according to various embodiments.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “three-dimensional structures” and the like as used herein refer generally to intended or actually fabricated three-dimensional configurations (e.g. of structural material or materials) that are intended to be used for a particular purpose. Such structures, etc. may, for example, be designed with the aid of a three-dimensional CAD system.

The term “electron beam” as used herein in various embodiments refers to any charged particle beam. The sources of charged particle beam can include an electron gun, a linear accelerator and so on.

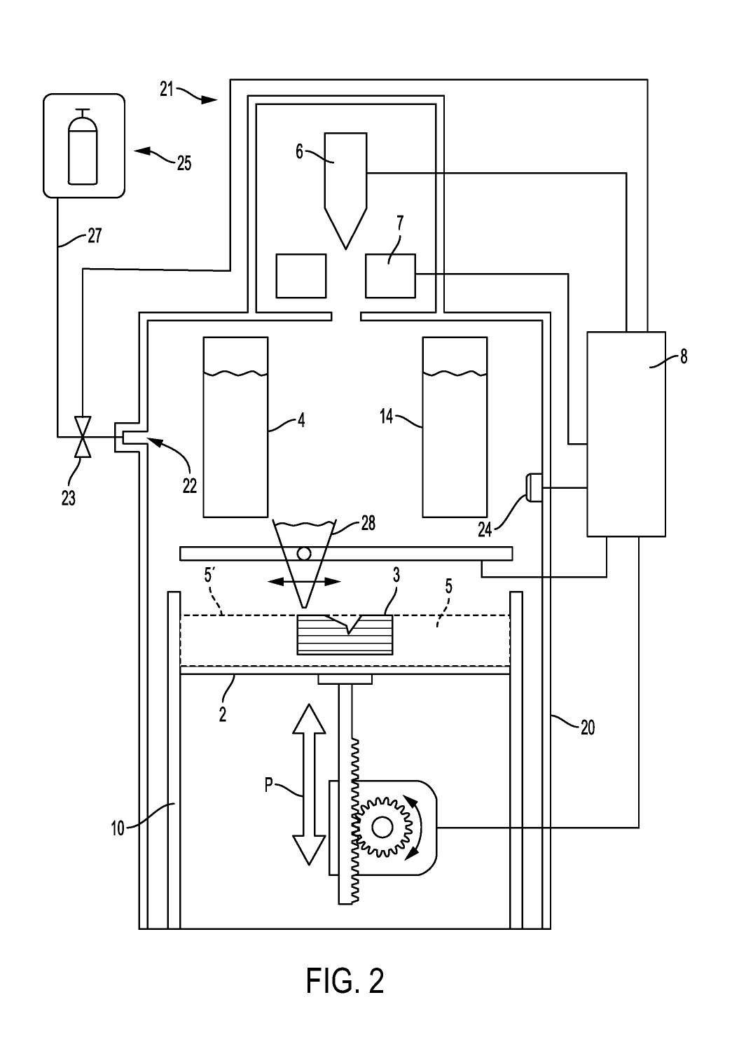

FIG. 2 depicts an embodiment of a freeform fabrication or additive manufacturing apparatus 21 in which the inventive methods according to the present invention may be implemented.

The apparatus 21 comprising an electron beam gun 6; deflection coils 7; two powder hoppers 4, 14; a build platform 2; a build tank 10; a powder distributor 28; a powder bed 5; and a vacuum chamber 20.

The vacuum chamber 20 is capable of maintaining a vacuum environment by means of a vacuum system, which system may comprise a turbo-molecular pump, a scroll pump, an ion pump and one or more valves which are well known to a skilled person in the art and therefore need no further explanation in this context. The vacuum system is controlled by a control unit 8.

The electron beam gun 6 is generating an electron beam which is used for melting or fusing together powder material provided on the build platform 2. The control unit 8 may be used for controlling and managing the electron beam emitted from the electron beam gun 6. At least one focusing coil (not shown), at least one deflection coil 7, an optional coil for astigmatic correction (not shown) and an electron beam power supply (not shown) may be electrically connected to the control unit 8. In an example embodiment of the invention the electron beam gun 6 generates a focusable electron beam with an accelerating voltage of about 15-60 kV and with a beam power in the range of 3-10 Kw. The pressure in the vacuum chamber may be 1×10-3 mbar or lower when building the three-dimensional article by fusing the powder layer by layer with the energy beam.

The powder hoppers 4, 14 comprise the powder material to be provided on the build platform 2 in the build tank 10. The powder material may for instance be pure metals or metal alloys such as titanium, titanium alloys, aluminum, aluminum alloys, stainless steel, Co—Cr alloys, nickel-based super-alloys and the like.

The powder distributor 28 is arranged to lay down a thin layer of the powder material on the build platform 2. During a work cycle the build platform 2 will be lowered successively in relation to a fixed point in the vacuum chamber. In order to make this movement possible, the build platform 2 is in one embodiment of the invention arranged movably in vertical direction, i.e., in the direction indicated by arrow P. This means that the build platform 2 starts in an initial position, in which a first powder material layer of necessary thickness has been laid down. Means for lowering the build platform 2 may for instance be through a servo engine equipped with a gear, adjusting screws, and the like.

An electron beam may be directed over the build platform 2 causing the first powder layer to fuse in selected locations to form a first cross section of the three-dimensional article. The beam is directed over the build platform 2 from instructions given by the control unit 8. In the control unit 8 instructions for how to control the electron beam for each layer of the three-dimensional article is stored.

After a first layer is finished, i.e., the fusion of powder material for making a first layer of the three-dimensional article, a second powder layer is provided on the build platform 2. The second powder layer is preferably distributed according to the same manner as the previous layer. However, there might be alternative methods in the same additive manufacturing machine for distributing powder onto the work table. For instance, a first layer may be provided by means of a first powder distributor 28, a second layer may be provided by another powder distributor. The design of the powder distributor is automatically changed according to instructions from the control unit 8. A powder distributor 28 in the form of a single rake system, i.e., where one rake is catching powder fallen down from both a left powder hopper 4 and a right powder hopper 14, the rake as such can change design.

After having distributed the second powder layer on the build platform, the energy beam is directed over the work table causing the second powder layer to fuse in selected locations to form a second cross section of the three-dimensional article. Fused portions in the second layer may be bonded to fused portions of the first layer. The fused portions in the first and second layer may be melted together by melting not only the powder in the uppermost powder layer but also remelting at least a fraction of a thickness of a layer directly below the uppermost powder layer.

When an electron beam is used, it is necessary to consider the charge distribution that is created in the powder as the electrons hit the powder bed 5. The charge distribution density depends on the following parameters: beam current, electron velocity (which is given by the accelerating voltage), spot size, beam scanning velocity, powder material and electrical conductivity of the powder, i.e. mainly the electrical conductivity between the powder grains. The latter is in turn a function of several parameters, such as temperature, degree of sintering and powder grain size/size distribution.

Thus, for a given powder, i.e. a powder of a certain material with a certain grain size distribution, and a given accelerating voltage, it is possible, by varying the beam current (and thus the beam power) and the beam scanning velocity, to affect the charge distribution.

By varying these parameters in a controlled way, the electrical conductivity of the powder can gradually be increased by increasing the temperature of the powder. A powder that has a high temperature obtains a considerably higher conductivity which results in a lower density of the charge distribution since the charges quickly can diffuse over a large region. This effect is enhanced if the powder is allowed to be slightly sintered during the pre-heating process. When the conductivity has become sufficiently high, the powder can be fused together, i.e. melted or fully sintered, with predetermined values of the beam current and beam scanning velocity.

A general function for describing the charge density that develops in the powder in an arbitrary scanning procedure will be a rather complex function of time and beam position since the charge density generated along one scanned path will be affected by the charge density generated along another scanned path if these paths are not very well separated in space and time. Thus, charge summation effects between different paths must be taken into account.

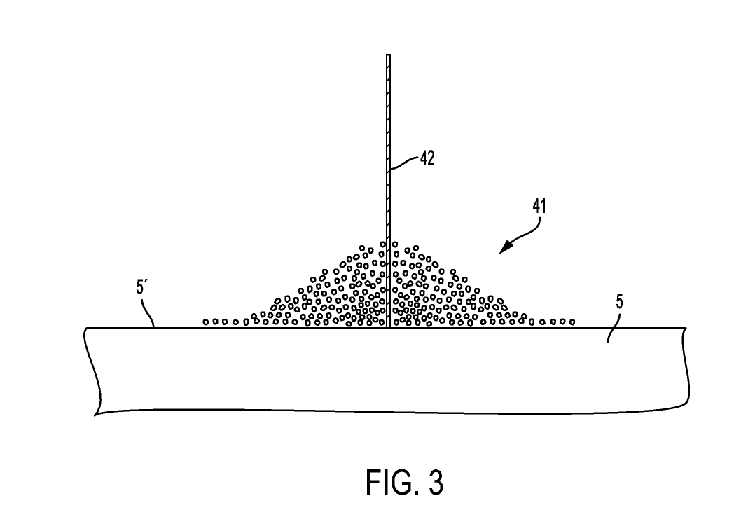

FIG. 3 shows the upper layer 5′ of the powder bed 5 of the powdery material with a charged particle cloud 41. The cloud is concentrated around the position where the electron beam 42 radiates the powdery material. With a higher electrical field, a larger cloud will occur around the radiating point.

External gas supply may be provided via a gas bottle 25 which is connectable to the additive manufacturing apparatus 21 via a pipe 27 and a valve 23, see FIG. 2. The valve is in this embodiment controlled by the control unit 8. When the valve is open gas from the gas source 25 will be provided into the additive manufacturing device 21 through an inlet 22. The valve may be set to any position between fully open and fully closed, i.e., the gas flow may be regulated by the valve 23. In an alternative embodiment a pressure and flow regulator may be provided directly on the gas source 25, leaving the only functionality of the valve 23 to be the opening and closing means for the gas into the additive manufacturing apparatus 21. The gas in the gas source may be used for loading the powder material with a predefined amount of gas and/or the finished three-dimensional article with a predefined amount of gas.

Ions created in the vacuum chamber should thus be above a predefined level in order to neutralize enough charges in the surface of the powder. The predefined level should be selected such that it keeps the electrical field strength below Eₘₐₓ. In doing so, enough of the powdery material is neutralized and lifting of powder is prohibited.

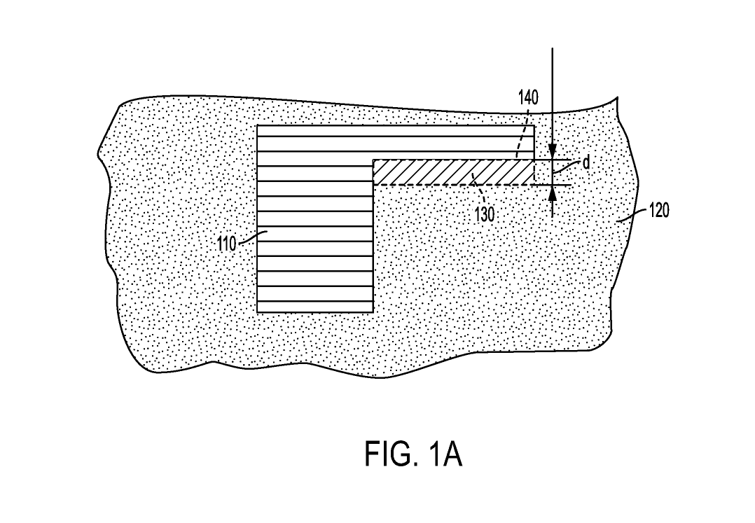

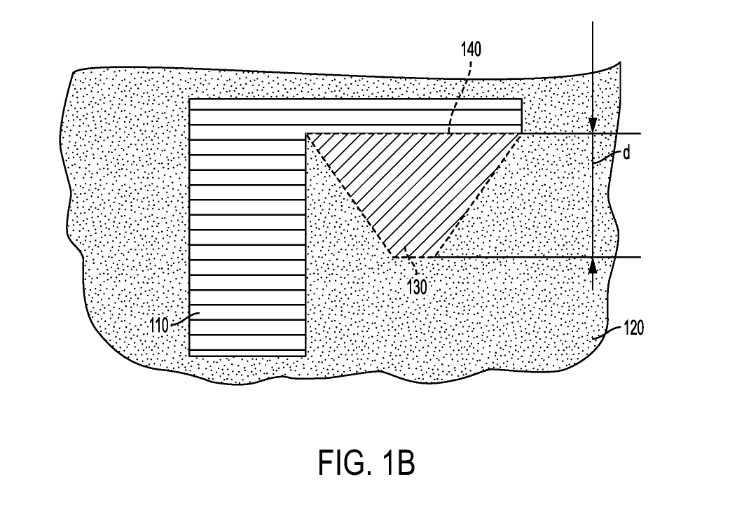

FIG. 1A depicts, in a schematic cross sectional view, a first example embodiment of a partly finished three-dimensional article 110. The three-dimensional article 110 is surrounded by unfused powder material 120. A negative surface of the three-dimensional article 110 is a surface which is starting on unfused powder material 120. The three-dimensional article 110 has a negative surface 140. If starting to fuse the negative surface 140 it will be provided on unfused powder material. There is a great risk that powder will start to smoke when fusing the first layer of the negative surface. According to the invention a preheating is therefore made of the area directly below the negative surface. The preheating is performed for a predefined number of layers before the actual negative surface 140 is to be fused. In FIG. 1A an area below the negative surface having a thickness d is preheated. The area below the negative surface times the thickness d defines a volume which is preheated and which stays unfused when the three-dimensional article is finished, i.e., the volume is not part of the finished three dimensional article. Another way of describing the invention is that the control unit looks ahead and if seeing a negative surface within a predetermined number of forthcoming cross sections, an area below such negative surface is started to be preheated for each layer until the actual negative surface is to be fused. In an example embodiment the preheating of the area below the negative surface may start 5 layers before the negative surface is to be fused. In another example embodiment the preheating of the area below the negative surface is starting 10 layers before the negative surface is to be fused. Alternatively such number may be altered if the thickness of the powder layers is varied, e.g., thicker powder layers may require fewer layers and thinner powder layers may require more layers.

Not only the smoke of powder is greatly reduced when the predefined numbers of layers directly below the negative surface is preheated but also the surface quality of the negative surface is improved with the volume which is preheated directly below the negative surface. Without preheating the surface quality is poor. With the preheating volume, the surface quality is improved, i.e., the negative surface has a smoother surface with the preheating volume compared to if no preheating volume is applied. The weldability of the powder material for the negative surface is improved with application of the preheating volume of powder material below the negative surface which stays unfused when the three-dimensional article is finished.

A negative surface can be the to be a sudden lateral extension of the three-dimensional article at a predetermined distance above a first cross section of the three-dimensional article.

A thickness of the powder layer in an additive manufacturing process may vary between 10-200 μm.

The preheating of the area may be made to a temperature range between 400-1300° C. The actual temperature range is strongly material dependent. For instance, the preheating range for Ti-6Al-4V may be 650-700° C., whereas for pure titanium is 550-600° C.

The preheating of the volume below the negative surface may be performed so that its mean temperature is at least 300° C. above the temperature of the same volume without the preheating. The increase of temperature of the volume directly below the negative surface is increasing the powder material electrical conductivity as well as removal of surface oxides which in turn will reduce the risk of powder smoke.

The volume may have equal area for each layers as depicted in FIG. 1A. However, the volume of preheated powder directly below the negative surface may have other shapes. In FIG. 1B it is depicted a volume directly below the negative surface having a v-shaped cross section. The volume will not be fused and is not part of the final three dimensional article. The powder material in the volume may be reused in a later additive manufacturing process.

During a preheating the powder provided on the build platform 2 is about to be brought to an appropriate temperature before fusing the powder. This preheating step may be performed by scanning the electron beam over the powder bed in an appropriate manner for heating the powder bed without creating powder smoke. This may be performed by leaving enough spacing between two consecutive scanning lines so the summation of charges in a first scanning line is not affecting the charges provided in the second scanning line.

The preheating temperature is strongly material dependent, which means that different materials require different preheating temperature intervals. The temperature chosen for the preheating may affect the internal stresses and fatigue properties of the final three dimensional article. When the heating is finalized or when no heating is needed, the process starts all over again by providing the next powder layer.

The pressure level during preheating may be kept at a relatively high pressure in order to ensure a safe suppression of smoke of powder which is very material dependent given the same power of the electron beam. The pressure level during fusion may be kept at a relatively low pressure in order to keep the electron beam quality as good as possible, i.e., as little as possible blurred by interaction of the atoms during the path from an electron beam filament to the powder layer.

A gas provided into the vacuum chamber may be capable of reacting chemically with or being absorbed by the finished three-dimensional article. The gas may be at least one or more in the group of: Hydrogen, deuterium, hydrocarbons, gaseous organic compounds, ammonia, nitrogen, oxygen, carbon monoxide, carbon dioxide, nitrogen, nitrous oxide, helium, Argon, Neon, Krypton, Xenon and/or Radon.

A mean pressure level during the preheating may be higher than a mean pressure level during the fusion of the selected locations. The reason of having a higher pressure level of the gas is to reduce or eliminate the likelihood of powder smoke. A certain number of ions are needed in the vacuum chamber in order to neutralize or decreasing the amount of the charges in the powder created by the ion beam when hitting the powder.

During the fusion one wants to keep the pressure level of the gases in the vacuum chamber at a minimum since the gas atoms may more or less influence the resolution of the electron beam. Depending on the type of ions present in the vacuum chamber there may be some differences in the pressure allowed for maintaining the same electron beam resolution for reasons as explained above.

In another aspect of the invention it is provided a program element configured and arranged when executed on a computer to implement a method as detailed herein. The program element may be installed in a non-transitory computer readable storage medium. The computer readable storage medium may be the control unit 8 or on another control unit. The computer readable storage medium and the program element, which may comprise computer-readable program code portions embodied therein, may further be contained within a non-transitory computer program product. Further details regarding these features and configurations are provided, in turn, below.

As mentioned, various embodiments of the present invention may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAIVI), Thyristor RAM (T-RAM), Zero-capacitor (Z-RAM), Rambus in-line memory module (RIM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like, as have been described elsewhere herein. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

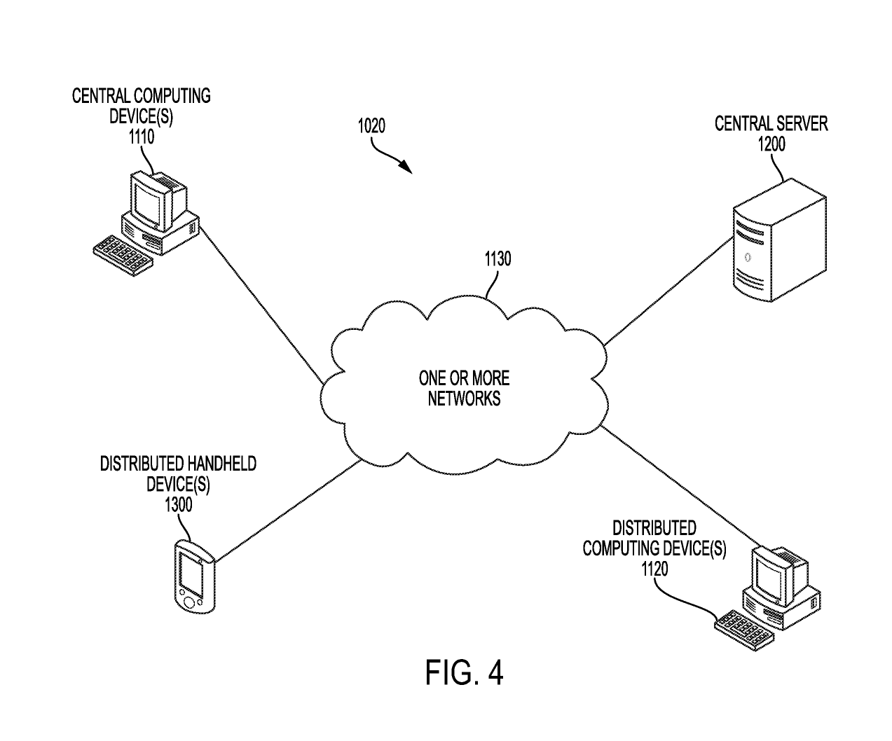

FIG. 4 is a block diagram of an exemplary system 1020 that can be used in conjunction with various embodiments of the present invention. In at least the illustrated embodiment, the system 1020 may include one or more central computing devices 1110, one or more distributed computing devices 1120, and one or more distributed handheld or mobile devices 1300, all configured in communication with a central server 1200 (or control unit) via one or more networks 1130. While FIG. 4 illustrates the various system entities as separate, standalone entities, the various embodiments are not limited to this particular architecture.

According to various embodiments of the present invention, the one or more networks 1130 may be capable of supporting communication in accordance with any one or more of a number of second-generation (2G), 2.5G, third-generation (3G), and/or fourth-generation (4G) mobile communication protocols, or the like. More particularly, the one or more networks 1130 may be capable of supporting communication in accordance with 2G wireless communication protocols IS-136 (TDMA), GSM, and IS-95 (CDMA). Also, for example, the one or more networks 1130 may be capable of supporting communication in accordance with 2.5G wireless communication protocols GPRS, Enhanced Data GSM Environment (EDGE), or the like. In addition, for example, the one or more networks 1130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 1020 may be configured to communicate with one another in accordance with techniques such as, for example, radio frequency (RF), Bluetooth™ infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the device(s) 1110-1300 are illustrated in FIG. 4 as communicating with one another over the same network 1130, these devices may likewise communicate over multiple, separate networks.

According to one embodiment, in addition to receiving data from the server 1200, the distributed devices 1110, 1120, and/or 1300 may be further configured to collect and transmit data on their own. In various embodiments, the devices 1110, 1120, and/or 1300 may be capable of receiving data via one or more input units or devices, such as a keypad, touchpad, barcode scanner, radio frequency identification (RFID) reader, interface card (e.g., modem, etc.) or receiver. The devices 1110, 1120, and/or 1300 may further be capable of storing data to one or more volatile or non-volatile memory modules, and outputting the data via one or more output units or devices, for example, by displaying data to the user operating the device, or by transmitting data, for example over the one or more networks 1130.

In various embodiments, the server 1200 includes various systems for performing one or more functions in accordance with various embodiments of the present invention, including those more particularly shown and described herein. It should be understood, however, that the server 1200 might include a variety of alternative devices for performing one or more like functions, without departing from the spirit and scope of the present invention. For example, at least a portion of the server 1200, in certain embodiments, may be located on the distributed device(s) 1110, 1120, and/or the handheld or mobile device(s) 1300, as may be desirable for particular applications. As will be described in further detail below, in at least one embodiment, the handheld or mobile device(s) 1300 may contain one or more mobile applications 1330 which may be configured so as to provide a user interface for communication with the server 1200, all as will be likewise described in further detail below.

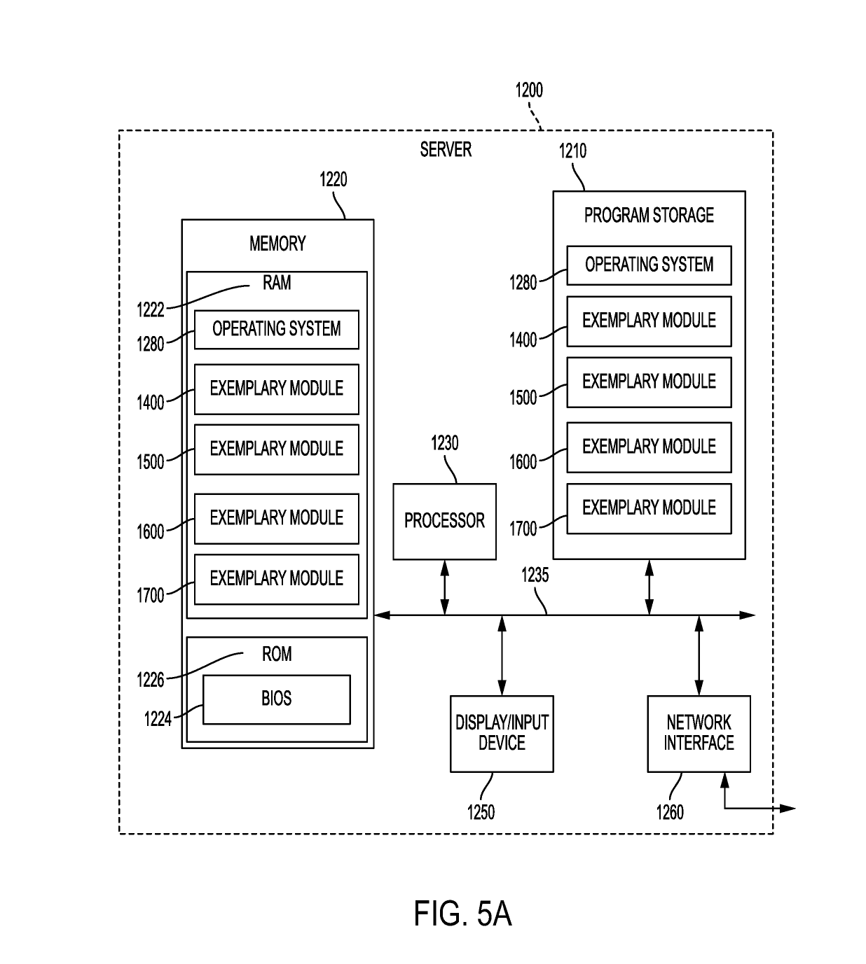

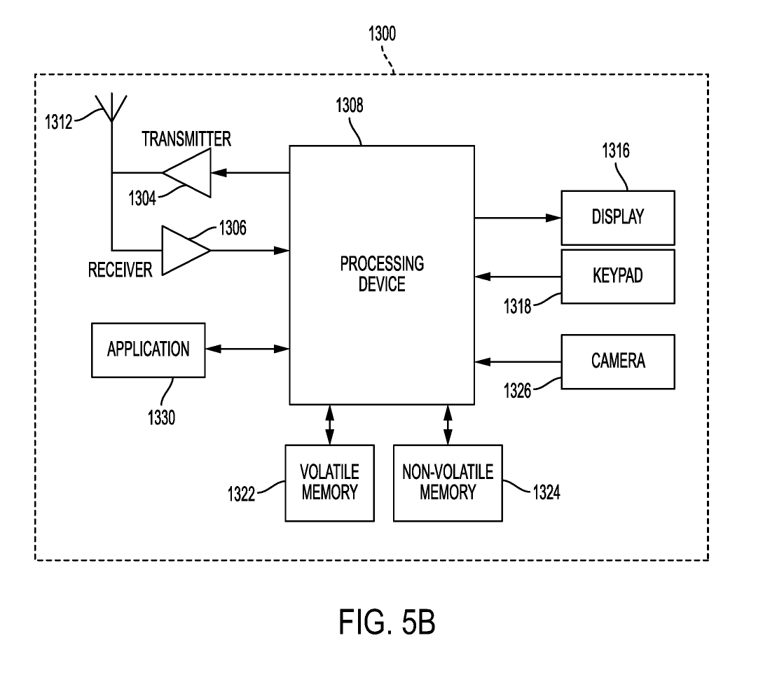

FIG. 5A is a schematic diagram of the server 1200 according to various embodiments. The server 1200 includes a processor 1230 that communicates with other elements within the server via a system interface or bus 1235. Also included in the server 1200 is a display/input device 1250 for receiving and displaying data. This display/input device 1250 may be, for example, a keyboard or pointing device that is used in combination with a monitor. The server 1200 further includes memory 1220, which preferably includes both read only memory (ROM) 1226 and random access memory (RAM) 1222. The server's ROM 1226 is used to store a basic input/output system 1224 (BIOS), containing the basic routines that help to transfer information between elements within the server 1200. Various ROM and RAM configurations have been previously described herein.

In addition, the server 1200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 1210 are connected to the system bus 1235 by an appropriate interface. The storage devices 1210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 1210 and/or memory of the server 1200 may further provide the functions of a data storage device, which may store historical and/or current delivery data and delivery conditions that may be accessed by the server. In this regard, the storage device 1210 may comprise one or more databases. The term “database” refers to a structured collection of records or data that is stored in a computer system, such as via a relational database, hierarchical database, or network database and as such, should not be construed in a limiting fashion.

A number of program modules (e.g., exemplary modules 1400-1700) comprising, for example, one or more computer-readable program code portions executable by the processor 1230, may be stored by the various storage devices 1210 and within RAM 1222. Such program modules may also include an operating system 1280. In these and other embodiments, the various modules 1400, 1500, 1600, 1700 control certain aspects of the operation of the server 1200 with the assistance of the processor 1230 and operating system 1280. In still other embodiments, it should be understood that one or more additional and/or alternative modules may also be provided, without departing from the scope and nature of the present invention.

In various embodiments, the program modules 1400, 1500, 1600, 1700 are executed by the server 1200 and are configured to generate one or more graphical user interfaces, reports, instructions, and/or notifications/alerts, all accessible and/or transmittable to various users of the system 1020. In certain embodiments, the user interfaces, reports, instructions, and/or notifications/alerts may be accessible via one or more networks 1130, which may include the Internet or other feasible communications network, as previously discussed.

In various embodiments, it should also be understood that one or more of the modules 1400, 1500, 1600, 1700 may be alternatively and/or additionally (e.g., in duplicate) stored locally on one or more of the devices 1110, 1120, and/or 1300 and may be executed by one or more processors of the same. According to various embodiments, the modules 1400, 1500, 1600, 1700 may send data to, receive data from, and utilize data contained in one or more databases, which may be comprised of one or more separate, linked and/or networked databases.

Also located within the server 1200 is a network interface 1260 for interfacing and communicating with other elements of the one or more networks 1130. It will be appreciated by one of ordinary skill in the art that one or more of the server 1200 components may be located geographically remotely from other server components. Furthermore, one or more of the server 1060 components may be combined, and/or additional components performing functions described herein may also be included in the server.

While the foregoing describes a single processor 1230, as one of ordinary skill in the art will recognize, the server 1200 may comprise multiple processors operating in conjunction with one another to perform the functionality described herein. In addition to the memory 1220, the processor 1230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 1200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 1200 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

FIG. 5B provides an illustrative schematic representative of a mobile device 1300 that can be used in conjunction with various embodiments of the present invention. Mobile devices 1300 can be operated by various parties. As shown in FIG. 5B, a mobile device 1300 may include an antenna 1312, a transmitter 1304 (e.g., radio), a receiver 1306 (e.g., radio), and a processing element 1308 that provides signals to and receives signals from the transmitter 1304 and receiver 1306, respectively.

The signals provided to and received from the transmitter 1304 and the receiver 1306, respectively, may include signaling data in accordance with an air interface standard of applicable wireless systems to communicate with various entities, such as the server 1200, the distributed devices 1110, 1120, and/or the like. In this regard, the mobile device 1300 may be capable of operating with one or more air interface standards, communication protocols, modulation types, and access types. More particularly, the mobile device 1300 may operate in accordance with any of a number of wireless communication standards and protocols. In a particular embodiment, the mobile device 1300 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 1300 may according to various embodiments communicate with various other entities using concepts such as Unstructured Supplementary Service data (US SD), Short Message Service (SMS), Multimedia Messaging Service (MMS), Dual-Tone Multi-Frequency Signaling (DTMF), and/or Subscriber Identity Module Dialer (SIM dialer). The mobile device 1300 can also download changes, add-ons, and updates, for instance, to its firmware, software (e.g., including executable instructions, applications, program modules), and operating system.

According to one embodiment, the mobile device 1300 may include a location determining device and/or functionality. For example, the mobile device 1300 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 1300 may also comprise a user interface (that can include a display 1316 coupled to a processing element 1308) and/or a user input interface (coupled to a processing element 1308). The user input interface can comprise any of a number of devices allowing the mobile device 1300 to receive data, such as a keypad 1318 (hard or soft), a touch display, voice or motion interfaces, or other input device. In embodiments including a keypad 1318, the keypad can include (or cause display of) the conventional numeric (0-9) and related keys (#, *), and other keys used for operating the mobile device 1300 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 1300 can also include volatile storage or memory 1322 and/or non-volatile storage or memory 1324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RI IM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 1300.

The mobile device 1300 may also include one or more of a camera 1326 and a mobile application 1330. The camera 1326 may be configured according to various embodiments as an additional and/or alternative data collection feature, whereby one or more items may be read, stored, and/or transmitted by the mobile device 1300 via the camera. The mobile application 1330 may further provide a feature via which various tasks may be performed with the mobile device 1300. Various configurations may be provided, as may be desirable for one or more users of the mobile device 1300 and the system 1020 as a whole.

It will be appreciated that many variations of the above systems and methods are possible, and that deviation from the above embodiments are possible, but yet within the scope of the claims. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Such modifications may, for example, involve using a different source of energy beam than the exemplified electron beam such as laser beam. Other materials than metallic powder may be used such as powder of polymers or powder of ceramics. Still further, although specific terms are employed herein, they are used in a generic and descriptive sense only and not for purposes of limitation.

1. A method for forming a three-dimensional article through successive fusion of parts of a metal powder bed, which parts corresponds to successive cross sections of the three-dimensional article, the method comprising the steps of:
distributing a powder layer on a work table inside a build chamber,
directing at least one beam from at least one high energy beam source over the work table causing the powder layer to fuse in selected locations to form a first cross section of the three-dimensional article,
lowering the work table a predetermined distance in Z-direction,
distributing a second powder layer on the work table inside the build chamber,
directing the at least one beam over the work table causing the second powder layer to fuse in selected locations to form a second cross section of the three-dimensional article, wherein the second layer is bonded to the first layer, and
preheating, with the at least one beam, an area of non-fused powder to a temperature within a predetermined temperature range a predetermined distance in Z-direction before the area is to be fused,
wherein the area times the distance in z-direction is defining a preheating volume of non-fused powder when the three dimensional article is finished.

2. The method according to claim 1, wherein the preheating of the area of non-fused powder is performed on at least five powder layers before the actual fusing of the area is taking place.

3. The method according to claim 1, wherein the preheating of the area of non-fused powder is performed on at least ten powder layers before the actual fusing is taking place.

4. The method according to claim 1, wherein a thickness of a powder layer is between 10-200 μm.

5. The method according to claim 1, wherein the temperature range is between 400-1300° C.

6. The method according to claim 1, wherein the preheating is performed so that a mean temperature within the preheating volume is at least 300° C. above a mean temperature of the same volume without preheating.

7. The method according to claim 1, wherein the preheating volume has a rectangular cross section.

8. The method according to claim 1, wherein the preheating volume has a trapezoid shaped cross section.

9. The method according to claim 1, wherein the area of the preheating volume, next to the area which is to be fused, is larger than the area which is to be fused.

10. The method according to claim 1, wherein the area of the preheating volume, next to the area which is to be fused, is fully overlapping with the area which is to be fused.

11. The method according to claim 1, wherein the area of the preheating volume, next to the area which is to be fused, is identical to the area which is to be fused.

12. The method according to claim 1, wherein the area of the preheating volume, next to the area which is to be fused, is centered with the area which is to be fused.

13. The method according to claim 1, wherein the high energy beam is either an electron beam or a laser beam.

14. The method according to claim 1, wherein the high energy beam is an electron beam and the build chamber is a vacuum chamber.

15. An apparatus for forming a three-dimensional article through successive fusion of parts of a metal powder bed, which parts corresponds to successive cross sections of the three-dimensional article, the apparatus comprising:
a build chamber;
a working table onto which layers of powdery material are to be placed;
at least one high energy beam source; and
at least one control unit,
wherein the apparatus is configured, via the at least one control unit, for:
distributing a layer on the work table inside the vacuum chamber,
directing the at least one e beam from the at least one high energy beam source over the work table causing the powder layer to fuse in selected locations to form a first cross section of the three-dimensional article,
distributing a second powder layer on the work table inside the build chamber,
directing the at least one beam over the work table causing the second powder layer to fuse in selected locations to form a second cross section of the three-dimensional article, wherein the second layer is bonded to the first layer, and
preheating, with the at least one beam, an area of non-fused powder to a temperature within a predetermined temperature range a predetermined distance in Z-direction before the area is to be fused,
wherein the area times the distance in z-direction defines a preheating volume of non-fused powder when the three dimensional article is finished.

16. The apparatus according to claim 15, wherein the preheating is performed so that a mean temperature within the preheating volume is at least 300° C. above a mean temperature of the same volume without preheating.

17. The apparatus according to claim 15, wherein the preheating volume has either a trapezoidal or a rectangular cross section.

18. The apparatus according to claim 15, wherein the area of the preheating volume, next to the area which is to be fused, is larger than and fully overlapping with the area which is to be fused.

19. The apparatus according to claim 15, wherein the area of the preheating volume, next to the area which is to be fused, is identical to and centered with the area which is to be fused.

20. The apparatus according to claim 15, wherein the high energy beam is either an electron beam or a laser beam.

21. The apparatus according to claim 15, wherein the high energy beam is an electron beam and the build chamber is a vacuum chamber.

22. A computer program product comprising at least one non-transitory computer-readable storage medium having computer-readable program code portions embodied therein, the computer-readable program code portions comprising at least one executable portion configured for:
directing at least one beam from at least one high energy beam source over a work table causing a powder layer thereon to fuse in selected locations to form a first cross section of the three-dimensional article,
lowering the work table a predetermined distance in Z-direction,
distributing a second powder layer on the work table inside the build chamber,
directing the at least one beam over the work table causing the second powder layer to fuse in selected locations to form a second cross section of the three-dimensional article, wherein the second layer is bonded to the first layer, and
preheating, with the at least one beam, an area of non-fused powder to a temperature within a predetermined temperature range a predetermined distance in Z-direction before the area is to be fused,
wherein the area times the distance in z-direction is defining a preheating volume of non-fused powder when the three dimensional article is finished.
